(19) United States
(12) Patent Application Publication
(10) Pub. No.: US 2014/0260792 A1
(43) Pub. Date: Sep. 18, 2014

(54) STARTER

(71) Applicant: REMY TECHNOLOGIES, LLC, Pendleton, IN (US)

(72) Inventor: Michael D. Bradfield, Anderson, IN (US)

(73) Assignee: Remy Technologies, LLC, Pendleton, IN (US)

(21) Appl. No.: 13/801,668

(22) Filed: Mar. 13, 2013

(51) Int. Cl. F02N 15/06

(52) U.S. Cl. CPC F02N 15/06
USPC 74/7 A

(57) ABSTRACT

Some embodiments include a starter that includes at least one solenoid coil winding that is integrated with a pinion and plunger assembly. Some embodiments include a starter with an output shaft including a rotational axis coupled to a pinion including pinion teeth, and at least one solenoid coil winding at least partially circumferentially surrounding the pinion, the pinion teeth and the output shaft. In some embodiments, the solenoid coil winding is capable of providing a magnetic field flux within the pinion, the output shaft or both. Some embodiments provide a starter with a pinion that can move bi-directionally with respect to the rotational axis of the output shaft. In other embodiments, the output shaft includes splines and the pinion includes a slot with spline contours. In some further embodiments, a starter control system includes a starter that is capable of being in communication with an electronic control unit.

### BACKGROUND

Some electric machines can play important roles in vehicle operation. For example, some vehicles can include a starter, which can, upon a user closing an ignition switch, lead to cranking of engine components of the vehicle. Some starters can include space-saving and efficient designs.

### SUMMARY

In some embodiments, the starter can include components of a solenoid that are substantially integrated within the starter. In some embodiments, the pinion performs the operation of a plunger while also operating as a pinion, eliminating the need for a shift lever.

Some embodiments include a starter with an output shaft including a rotational axis coupled to a pinion including pinion teeth, and at least one solenoid coil winding at least partially circumferentially surrounding the pinion, the pinion teeth and the output shaft.

In some embodiments, the solenoid coil winding is capable of providing a magnetic field flux within the pinion, the output shaft or both. In some embodiments, the pinion can move bi-directionally with respect to the rotational axis of the output shaft. Some embodiments include a starter with at least one pinion biasing member coupled to the output shaft and the pinion and configured and arranged to at least partially move the pinion. In some embodiments, the pinion includes a sleeve at least partially circumscribing the pinion.

In some further embodiments, the starter includes a stop structure and a guide structure configured and arranged to guide the pinion and to prevent over-travel of the pinion on the output shaft. In some other embodiments, the output shaft includes splines and the pinion includes a slot with spline contours. Some embodiments include helical splines and helical spline contours, or straight splines and straight contours in alternative embodiments.

In some other embodiments, a starter control system includes a starter that is capable of being in communication with an electronic control unit. In some embodiments, the electronic control unit is configured and arranged to enable a current flow through at least one solenoid coil winding and the motor. Some further embodiments include a starter control system wherein a priming current can be coupled to the motor in response to the occurrence of a change of mind stop-start starting episode.

### DESCRIPTION OF THE DRAWINGS

FIG. 1 is a diagram of a machine control system according to one embodiment of the invention.

FIGS. 2A and 2B are cross-sectional views of conventional starters.

FIGS. 3A and 3B are cross-sectional views of conventional solenoid assemblies.

FIG. 4 shows a cross-sectional view of a pinion-plunger solenoid assembly according to one embodiment of the invention.

FIG. 5 shows a cross-sectional view of the pinion-plunger solenoid assembly illustrating pinion boundaries according to one embodiment of the invention.

FIG. 6A shows a cross-sectional view of a pinion-plunger solenoid assembly showing the magnetic flux path according to one embodiment of the invention.

FIG. 6B shows a cross-sectional view of a pinion-plunger solenoid assembly including a sleeve showing the magnetic flux path according to one embodiment of the invention.

FIG. 7A illustrates a partial cross-sectional view of a pinion-plunger solenoid assembly according to one embodiment of the invention.

FIG. 7B illustrates a partial cross-sectional view of a pinion-plunger solenoid assembly according to one embodiment of the invention.

FIG. 8 shows an axial cross-sectional view of a pinion-plunger solenoid assembly interfacing with a ring-gear according to one embodiment of the invention.

FIG. 9 shows a graph of pinion-plunger solenoid assembly Force as a function of pinion-stop gap distance according to at least one embodiment of the invention.

Corresponding reference characters indicate corresponding parts throughout the several views.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

The following discussion is presented to enable a person skilled in the art to make and use embodiments of the invention. Various modifications to the illustrated embodiments will be readily apparent to those skilled in the art, and the generic principles herein can be applied to other embodiments and applications without departing from embodiments of the invention. Thus, embodiments of the invention are not intended to be limited to embodiments shown, but are to be accorded the widest scope consistent with the principles and features disclosed herein. The following detailed description is to be read with reference to the figures, in which like elements in different figures have like reference numerals. The figures, which are not necessarily to scale, depict selected embodiments and are not intended to limit the scope of embodiments of the invention. Skilled artisans will recognize the examples provided herein have many useful alternatives that fall within the scope of embodiments of the invention.

FIG. 1 illustrates a starter control system 10 including a starter 12 according to one embodiment of the invention. The system 10 can also include a power source 14, such as a battery, an electronic control unit 16, one or more sensors 18, and an engine 20, such as an internal combustion engine, a clutch 30 (e.g., an overrunning clutch), a gear train 24, and a pinion 32. Moreover, in some embodiments, the starter 12 can comprise a plurality of shafts 38 that can be configured and arranged to transfer movement from the motor 26 to the pinion 32. In some embodiments, a vehicle, such as an automobile, can comprise the system 10, although other vehicles can include the system 10. In some embodiments, non-mobile apparatuses, such as stationary engines, can comprise the system 10.

In most modern vehicle systems, conventional starters 12 are coupled with a starter solenoid 28, and the starter 12 and starter solenoid 28 are separate modules. The starter solenoid 28, (also known as a starter relay), is an electromagnetically actuated link between the ignition system, the starter 12 and the power source 26, (i.e. a combustion engine). The starter solenoid 28, upon activation of the ignition system by a relatively low current, relays a large current, (usually from a battery system), to the starter 12, which then engages the pinion 32 with the ring gear 36 of the engine 26. In most conventional starters 12, when the current flows through the starter solenoid 28, it operates a plunger 34 which engages the pinion 32 and ring gear 36.

A conventional starter system that includes a separate starter solenoid 28 is depicted in more detail in FIGS. 2A and 2B. The starter 12 can comprise a housing 22, a gear train 24, a brushed or brushless motor 26, a solenoid assembly 28, a clutch 30 (e.g., an over-running clutch), and a pinion 32. In response to a signal (e.g., a user closing a switch, such as an ignition switch), the solenoid assembly 28 can cause a first plunger 34 to move the pinion 32 into an engagement position with a ring gear 36 of a crankshaft of the engine 20. Further, the signal can lead to the motor 26 generating an electromotive force, which can be coupled through the gear train 24 to the pinion 32 engaged with the ring gear 36. The pinion 32 can move the ring gear 36, which can crank the engine 20, leading to ignition of the engine 20. In some starters 12, the clutch 30 can aid in reducing a risk of damage to the starter 12 and the motor 26 by disengaging the pinion 32 from a shaft 38 connecting the pinion 32 and the motor 26 (e.g., allowing the pinion 32 to free spin if it is still engaged with the ring gear 36).

In conventional starters such as those shown in FIGS. 2A and 2B, the solenoid assembly 28 can comprise one or more configurations attached to the housing 22 of the starter. The solenoid assembly 28 can comprise the first plunger 34, a coil winding 40, and a plurality of biasing members 42 (e.g., springs or other structures capable of biasing portions of the solenoid assembly 28). A first end of a shift lever 44 can be coupled to the first plunger 34 and a second end of the shift lever 44 can be coupled to the pinion 32 and/or a shaft 38 that can operatively couple together the motor 26 and the pinion 32. As a result, at least a portion of the movement created by the solenoid assembly 28 can be transferred to the pinion 32 via the shift lever 44 to engage the pinion 32 with the ring gear 36, as previously mentioned.

As shown in FIGS. 3A and 3B, the solenoid assembly 28 can comprise at least a plunger-return biasing member 42a and a contact over-travel biasing member 42b. When the starter 12 is activated (e.g., by the user closing an ignition switch), the system 10 can energize the coil winding 40, which can cause movement of the first plunger 34 (e.g., in a generally axial direction). As shown in FIGS. 2B and 3B, a typical solenoid assembly 28 can comprise more than one coil winding 40a and 40b. A first coil winding 40a can be configured and arranged to move the first plunger 34 from the home position (i.e., a position occupied by the first plunger 34 when little to no current flows through any of the coil windings 40) to the artificial stopping point. For example, current flowing through the first coil winding 40a can create a magnetic field sufficient to move the first plunger 34 from the home position to the artificial stop, but the magnetic field can be of a magnitude that is insufficient to overcome the resistive force of the auxiliary biasing member 42d. As a result, activation of the first coil winding 40a can move the first plunger 34 to the artificial stop. For example, current flowing through the coil winding 40 can draw-in or otherwise move the first plunger 34, and this movement can be translated to engagement of the pinion 32, via the shift lever 44, (i.e., the magnetic field created by current flowing through coil winding 40 can cause the first plunger 34 to move). Some starter solenoids 28 also utilize a second coil winding 40b that can be configured and arranged to move the first plunger 34 from the artificial stop to a position where the plunger contacts 48 can engage the first contacts 46 to close the circuit and provide current from the power source 14 to the motor 26. The current circulating through the coil windings 40a, 40b can originate from the power source 14 (e.g., a battery), and the electronic control unit 16 can control the current flow to one, some, or all of the coil windings 40a, 40b from the power source 14 so that the first plunger 34 moves after the electronic control unit 16 transmits the necessary signals for current to flow to the coil windings 40a, 40b.

The vast majority of modern vehicle systems utilize a starter 12 and starter solenoid assembly 28 that are designed as separate modules connected mechanically by a shift lever 44, as described previously. In some embodiments of the invention, the solenoid assembly 28 can be substantially or completely integral with the starter assembly, (i.e. they are not separate, discrete modules). In some embodiments of the invention, the pinion 32 is the active plunger in the engagement, while also performing the function of a pinion 32 as previously described.

Some embodiments of the invention include a starter 400 with an integrated solenoid 430. As described in various embodiments below, the starter 400 represents a substantial and useful departure from conventional starter technology described previously, and provides many improvements over conventional starter systems. The benefits of some embodiments include a more space-efficient design and reduced cost.

As discussed earlier, in some embodiments, the solenoid 28 and plunger 34 are one and the same part. In other words, the pinion (shown as 480 in FIG. 4) can be part of its own engagement solenoid (shown as 430 in FIG. 4), and there is no need for a separate solenoid and shift mechanism. In some embodiments, the entire solenoid 430 is nestled inside the housing 22 of the starter 400 and requires very little modification to the existing motor envelope. The pinion 480 rides on the output shaft (shown as 440 in FIG. 4) and is driven through a spline (with 490a, 490b shown as alternative embodiments) on the output shaft 440 and mating features (with alternative embodiments 493a and 493b shown) on the inner diameter of the pinion 480. In some embodiments, at the bottom of the nose housing 415 is an iron stop 425 that functions like a normal stop. When the individual coils are energized, the flux linking the end of the pinion 480 and the inner diameter area of this stop 425 creates a magnetic force that draws the pinion 480 toward the stop 425. As the pinion 480 draws closer, this magnetic force increases due to the lower air gap reluctance and higher flux density in the parts. In some embodiments of the invention, the pinion 480 never physically touches the stationary stop 425, preventing frictional losses between the two rotating and stationary surfaces. The stop point for the pinion 480 can be established either through a solid stack of the return spring 450 or a sleeve that fits over the return spring (not shown).

In some embodiments of the invention, the housing of the solenoid, (iron stop, solenoid, coil windings, spools, iron core and iron guide) comprises one piece that is secured inside the nose housing 415. In some further embodiments, a steel sleeve 492 is added around the pinion 480 to accommodate designs where the diameter of the pinion teeth 470 may protrude larger than the body of the pinion 480.

As discussed previously, FIG. 1 illustrates a starter control system 10 according to one embodiment of the invention. In some embodiments, the starter 12 of the system 10 can include the new starter 400 with the substantially integrated solenoid 430. In some embodiments, the control system 10 can be configured and arranged to enable a “stop-start” starting episode. For example, the control system 10 can start an engine 20 when the engine 20 has already been started (e.g., during a “cold start” starting episode) and the vehicle continues to be in an active state (e.g., operational), but the engine 20 is temporarily inactivated (e.g., the engine 20 has substantially or completely ceased moving). Moreover, in some embodiments, in addition to, or in lieu of being configured and arranged to enable a stop-start starting episode, the control system 10 can be configured and arranged to enable a “change of mind stop-start” starting episode. The control system 10 can start an engine 20 when the engine 20 has already been started by a cold start starting episode and the vehicle continues to be in an active state and the engine 20 has been deactivated, but continues to move (i.e., the engine 20 is decelerating). For example, after the engine receives a deactivation signal, but before the engine 20 substantially or completely ceases moving, the user can decide to reactivate the engine 20 so that the pinion 480 engages the ring gear 36 as the ring gear 36 is decelerating, but continues to move (e.g., rotate). After engaging the ring gear 36, the motor 26 can restart the engine 20 via the pinion 480 engaged with the ring gear 36. In some embodiments, the control system 10 can be configured for other starting episodes, such as a conventional “soft start” starting episodes (e.g., the motor 26 is at least partially activated during engagement of the pinion 480 and the ring gear 36).

As previously mentioned, in some embodiments, the control system 10 can be configured and arranged to start the engine 20 during a change of mind stop-start starting episode. For example, after a user cold starts the engine 20, the engine 20 can be deactivated upon receipt of a signal from the electronic control unit 16 (e.g., the vehicle is not moving and the engine 20 speed is at or below idle speed, the vehicle user instructs the engine 20 to inactivate by depressing a brake pedal for a certain duration, etc.), the engine 20 can be deactivated, but the vehicle can remain active (e.g., at least a portion of the vehicle systems can be operated by the power source 14 or in other manners). At some point after the engine 20 is deactivated, but before the engine 20 ceases moving, the vehicle user can choose to restart the engine 20 by signaling the electronic control unit 16 (e.g., via releasing the brake pedal, depressing the acceleration pedal, etc.). After receiving the signal, the electronic control unit 16 can use at least some portions of the starter control system 10 to restart the engine 20. For example, in order to reduce the potential risk of damage to the pinion 480 and/or the ring gear 36, a speed of the pinion 480 can be substantially synchronized with a speed of the ring gear 36 (i.e., a speed of the engine 20) when the starter 400 attempts to restart the engine 20.

As described earlier, some embodiments include a starter 400 with components of the solenoid that are substantially integrated in the starter 400. In some embodiments, the pinion functions to perform the operation of the plunger 34, eliminating the need for the shift lever 44. For example, FIG. 4 illustrates one embodiment of the a pinion-plunger solenoid assembly 480 comprising a housing 410, a solenoid winding 430 and spool 435 substantially surrounding an iron core 420, within a nose housing 415, and positioned radially around an output shaft 440 including a rotational axis 405. The assembly 400 includes a pinion 480 (functioning as its own plunger), pinion teeth 470, and helical spline 490a. As shown, in some embodiments, the pinion 480 rides on the output shaft 440 and is driven through the helical spline 490a on the shaft 440, mated through a bushing 460, and conventional mating features on the inner diameter of the pinion 480 (not shown). In some embodiments, the output shaft 440 further includes a biasing member and return spring 450. As shown, in some embodiments, the output shaft 440 is coupled through one end of the nose housing 415 via bushing 460. In some embodiments, the pinion 480 is coupled to the helical spline 490a and a clutch and planetary gear set 485. In some embodiments, the nose housing 415 further includes a stop structure 425 and a guide structure 428. In some embodiments, an iron stop 425 is located substantially adjacent the nose housing 415 to act as a final abutment for the pinion 480 at the nose end 416 of the nose housing 415.

In some embodiments, during normal operation after receiving a restart signal, the starter control system 10 can begin a process to restart the engine 20. The electronic control unit 16 can enable current to flow from the power source 14 to one or more electromagnetic coil windings. For example, as shown in FIG. 4, in some embodiments, the assembly 400 can comprise a solenoid coil winding 430. In some embodiments, the electronic control unit 16 can at least partially regulate a current flow through the solenoid coil winding 430 via a switch (not shown). In some embodiments of the invention, the solenoid coil winding 430 may comprise one or more solenoid coil windings connected in series, each separately controllable by the electronic control unit 16 through one or more switches (not shown).

In some other embodiments, the solenoid coil windings 430 can be connected in parallel. In some embodiments, wiring connecting the solenoid coil windings 430 is routed out of the nose housing 415 and connected to a controlled voltage source. The connection and associated pin-out assembly (not shown) can be placed near a mounting flange (not shown), and in some other embodiments the connection and associated pin-out assembly can be routed back into the solenoid region of the main motor contacts (not shown).

Some embodiments of the assembly 400 include a housing that comprises a low carbon steel. In some embodiments, the use of a low carbon steel results in a lower magnetic reluctance path for the flux. Therefore, fewer amp-turns are required for a given flux-density. Low carbon steel (e.g. American Iron and Steel Institute grade 1008 or 1010) requires less amp-turns for a given flux density level than higher carbon steels (e.g. American Iron and Steel Institute grade 1040 for example). In some embodiments, this design feature also minimizes the flux path through the pinion which comprises a much harder steel, and therefore a much higher reluctance path.

Turning now to FIG. 5, in some embodiments, once current begins to flow, an electromagnetic field flux is generated within the assembly 400. FIG. 6A for example illustrates a cross-sectional view of the assembly 400 including an approximate representation of the magnetic flux path 401 according to one embodiment of the invention.

As illustrated in FIG. 5, in some embodiments, the electromagnetic field acting on the pinion 480 and output shaft 440 causes the pinion 480 and output shaft 440 to move towards the iron stop 425 axially with respect to the axis 405, and there is a point of maximum travel (depicted as the dotted outline 510 in FIG. 5). As illustrated in FIG. 6A, a magnetic field flux 401 flows through the iron core 420, the pinion 480 and the iron stop 435, and iron guide 428. In some embodiments, the movement of the pinion 480 and output shaft 440 towards the iron stop 425 further causes of the compression of the return spring 450. In some embodiments, in normal operation, the end of the pinion 480 is designed to never touch the stationary iron stop 425. This assures there is no friction loss between the rotating surface of the end of the pinion 480 and the stationary surface of the iron stop 425.

As shown in FIG. 6B, in some embodiments, a steel sleeve 492 can be coupled to and at least partially circumscribe the pinion 480. In some embodiments, the steel sleeve 492 can be made of low carbon steel (e.g. American Iron and Steel Institute grade 1008 or grade 1010). The use of low carbon steel results in a lower magnetic reluctance path for the magnetic flux. In some embodiments, the steel sleeve 492 is cylindrical-shaped, and positioned directly over pinion 480. In some embodiments, the pinion 480 requires a high carbon grade steel that can be hardened, which requires a higher current within the coil 430. In some embodiments, the use of a steel sleeve 492 facilitates a reduction of the current in the coil 430 to provide sufficient magnetic flux excitation necessary to induce movement of the pinion 480. As shown in FIG. 6B, in some embodiments of the invention, the flux path extends through the steel sleeve 492 component in addition to the other components shown in FIG. 6A, while also minimizing the flux path through the pinion 480.

In some embodiments, the components of the pinion-plunger solenoid assembly 400 (iron stop 425, solenoid coil windings 430, spools 435, iron core 420 and iron guide 428) are assembled as one piece and positioned inside the nose housing 415. However, in some embodiments of the invention, due to the diameter of the pinion teeth 470, the teeth may protrude larger than the pinion body (depending on actual tooth count).

As described earlier, some embodiments include a starter 12 with components of the solenoid that are substantially integrated in the starter 12. As shown in FIGS. 4-6B, the pinion-plunger solenoid assembly 400 includes a pinion 480, pinion teeth 470, and helical spline 490a. Furthermore, some embodiments can include alternative a pinion 480 configurations. For example, FIG. 7A illustrates a partial cross-sectional view of a pinion-plunger solenoid assembly 400 according to one embodiment of the invention. As illustrated in FIG. 7A, in some embodiments, the pinion 480 can include a slot 493a comprising a helical spline contour, and the output shaft 440 can include helical splines 490a configured and arranged to at least partially couple with the helical spline contour of slot 493.

In some further embodiments, alternative pinion 480 and output shaft 440 coupling architectures can be used. For example, as shown in FIG. 7B according to one embodiment of the invention, the pinion 480 can include a slot 493b comprising a straight spline contour, and the output shaft 440 can include straight splines 490b configured and arranged to at least partially couple with the straight spline contour of slot 493b.

FIG. 8 shows an axial cross-sectional view of a pinion-plunger solenoid assembly 400 interfacing with a ring-gear 36. As shown, in one embodiment, the nose housing 415 encloses the pinion 480, which can operatively engage the ring gear 36. As illustrated, pinion-plunger solenoid assembly 400 houses the iron core 420 and solenoid coil winding 430 within the nose housing 415 and is axially positioned relative to the ring gear 36. Some embodiments can include a solenoid that comprise a single solenoid coil winding 430, whereas in other embodiments, a plurality of cores (i.e. a plurality of iron core 420 and solenoid coil winding 430 structures) can be used. In those embodiments that comprise a plurality of smaller diameter solenoid coil windings, less copper wire can be used for a given magnetic flux level. Referring back to FIG. 1, in some embodiments of the invention, the starter control system 10 can include a starter 12 that utilizes the pinion-plunger solenoid assembly 400 with substantially integrated solenoid (as previously described and illustrated in FIGS. 4-7B), a power source 14, such as a battery, an electronic control unit 16, one or more sensors 18 such as an engine speed sensor, and an engine 20, such as an internal combustion engine. In some embodiments, the engine speed sensor 18 can detect and transmit data to the electronic control unit 16 that correlates to the speed of the engine 20, the crankshaft, and/or the ring gear 36. In some embodiments, the engine speed sensor 18 can communicate with the electronic control unit 16 via conventional wired and/or wireless communication protocols. In some embodiments, when the starter control system 10 receives a signal to start the engine, the starter control system 10 can begin a process to restart the engine 20. The electronic control unit 16 can enable current to flow from the power source 14 to the solenoid coil winding 430. Once current begins flowing an electromagnetic field flux is generated, (shown as flux paths in FIG. 6A and FIG. 6B). In some embodiments, as the electromagnetic field acting on the pinion 480 and output shaft 440 causes the pinion and plunger and output shaft to move towards the iron stop 425, a point of maximum travel can be reached (depicted as the dotted outline 510) resulting in engagement of the ring-gear 36. After engaging the ring gear 36, the motor 26 can restart the engine 20 via the pinion 480 engaged with the output shaft 440 and with the ring gear 36.

In some embodiments, after partial or total completion of the starting event (e.g., the engine has at least partially turned over and combustion has begun), the solenoid coil winding 430 can be at least partially de-energized. In some embodiments, the reduction or removal of force retaining the pinion 480 in place (i.e., the magnetic field created by current flowing through the coil winding 430) can enable the compressed biasing members 450 to expand and return the pinion 480 to its original position. Accordingly, the pinion 480, now under the mechanical force exerted by the compressed biasing members 450, can withdraw from the ring gear 36 and return to its original position within the nose housing 415 (shown as the solid outline of the pinion 480 in FIG. 4 and FIG. 5). In some embodiments, the control system 10 can be configured for other starting episodes, such as a conventional “soft start” starting episodes (e.g., the motor 26 is at least partially energized during engagement of the pinion 480 and the ring gear 36).

FIG. 9 shows a graph of a pinion 480 force and travel curve according to at least one embodiment of the invention. In some embodiments, the axial force 820 acting on the pinion 480 is shown as a function of pinion to stop gap distance 810. In some embodiments as shown, when the pinion has bottomed 830, the axial force 820 and the magnetic field flux 840 acting on the pinion 480 is close to a maximum. In some embodiments, after the solenoid coil winding 430 is at least partially de-energized, the magnetic force 840 on the pinion 480 decreases, and reduction or removal of force retaining the pinion 480 in place can enable the compressed biasing members 450 to expand (see region 880 in FIG. 9), thereby returning the pinion 480 to its original position within the nose housing 415 (shown as 870 in FIG. 9).

It will be appreciated by those skilled in the art that while the invention has been described above in connection with particular embodiments and examples, the invention is not necessarily so limited, and that numerous other embodiments, examples, uses, modifications and departures from the embodiments, examples and uses are intended to be encompassed by the claims attached hereto. The entire disclosure of each patent and publication cited herein is incorporated by reference, as if each such patent or publication were individually incorporated by reference herein. Various features and advantages of the invention are set forth in the following claims.

1. A starter comprising:
an output shaft coupled to a pinion including pinion teeth,
the pinion configured and arranged for bi-directional movement with respect to a rotational axis of the output shaft;
at least one solenoid coil winding at least partially circumferentially surrounding the pinion, the pinion teeth and the output shaft,
the solenoid coil winding configured and arranged to provide a magnetic field flux within at least one of the pinion and the output shaft to induce at least some of the bi-directional pinion movement.

2. The starter of claim 1, further including at least one pinion biasing member coupled to the output shaft and the pinion, the at least one pinion biasing member configured and arranged to at least partially move the pinion.

3. The starter of claim 1, wherein the output shaft further comprises helical splines and the pinion includes a slot with a helical spline contour; and
wherein the pinion is configured and arranged to enable bi-directional movement of the pinion on the helical splines when coupled with the helical spline contour.

4. The starter of claim 1, wherein the output shaft further comprises straight splines and the pinion includes a slot with a straight spline contour; and
wherein the pinion is configured and arranged to enable bi-directional movement of the pinion on the straight splines when coupled with the straight spline contour.

5. The starter of claim 1, wherein the pinion further includes a sleeve at least partially circumscribing the pinion.

6. The starter of claim 5, wherein the sleeve comprises a low carbon steel.

7. The starter of claim 1, further comprising:
a stop structure,
configured and arranged to prevent over-travel of the pinion on the output shaft.

8. The starter of claim 1 further comprising a guide structure configured and arranged to guide the pinion.

9. A starter capable of being controlled by an electronic control unit, the starter further comprising:
a motor configured and arranged to be coupled to an engine;
a clutch and a planetary gear set;
an output shaft coupled to a pinion including pinion teeth,
the pinion configured and arranged for bi-directional movement with respect to a rotational axis of the output shaft;
at least one solenoid coil winding at least partially circumferentially surrounding the pinion, the pinion teeth and the output shaft,
the solenoid coil winding configured and arranged to provide a magnetic field flux encircling at least one of the pinion and the output shaft sufficient to induce at least some of the bi-directional movement; and
wherein in response to a signal from the electronic control unit, the pinion can be actuated to engage a ring gear of the engine.

10. The starter of claim 9, further including at least one pinion biasing member coupled to the output shaft and the pinion, the at least one pinion biasing member configured and arranged to at least partially move the pinion.

11. The starter of claim 9, wherein the electronic control unit is configured and arranged to enable a current flow through at the least one solenoid coil winding and the motor.

12. The starter of claim 11, wherein a priming current can be coupled to the motor in response to an occurrence of a change of mind stop-start starting episode.
